(19) United States
(12) Patent Application Publication
(10) Pub. No.: US 2013/0244613 A1
(43) Pub. Date: Sep. 19, 2013

(54) Mobile Device Security System and Method

(71) Applicant: Wesley W. Whitmyer, JR., Stamford, CT (US)

(72) Inventor: Wesley W. Whitmyer, JR., Stamford, CT (US)

(21) Appl. No.: 13/420,044

(22) Filed: Mar. 14, 2012

(51) Int. Cl. H04W 12/06; H04W 12/08

(52) U.S. Cl. 455/411

(57) ABSTRACT

A mobile device including a user interface, a plurality of software modules receiving a plurality of device activity data concerning one or more activities of the mobile device, software executing on the mobile device for presenting, via the user interface, a prompt for first device activity data indicative of a past activity of the mobile device, software executing on the mobile device for receiving a response to the prompt via the user interface, and software executing on the mobile device for verifying the accuracy of the response and unlocking the mobile device if the response corresponds to the first device activity data.

### FIELD OF THE INVENTION

The invention relates to mobile device security, and more specifically to a system and method for preventing unauthorized access to mobile devices.

### BACKGROUND OF THE INVENTION

As mobile device users increasing rely on their devices for accessing and storing sensitive information, it is important to protect mobile devices with a password or other security measure. However, existing security measures on mobile devices are inadequate and may lead to unauthorized access if the mobile device is ever lost or stolen. For example, many mobile devices require only the entry of a numeric password to unlock the device. Such passwords are susceptible to hacking when a simple password is used or when the number of characters in the password is minimal.

Smartphones with touch screen displays are becoming more prevalent, which raises additional security concerns. When a keypad is displayed on a touch screen, often fingerprints or smudges are left in the locations touched by the user. This may allow an unauthorized user to see what password was previously entered and access the device. As an alternative to requiring a numeric or alphanumeric password, some smartphones require a user to trace a pattern on the touch screen to unlock the device. This is also susceptible to hacking since the pattern can readily be seen and retraced on the screen.

It is therefore desired to provide improved security measures for mobile devices.

### SUMMARY OF THE INVENTION

Accordingly, it is an object of the present invention to provide improved security measures for mobile devices. It is a further object of the present invention to provide a two-factor or two-step security measure. It is a further object to provide a security measure which requires knowledge of activities previously performed on or by the mobile device, such as past locations of the device, and past interactions with applications or systems on the mobile device.

These and other objectives are achieved by providing a system for securing and unlocking a mobile device, including a mobile processor, software executing on the processor for storing a plurality of device activity data, software executing on the processor for prompting a user to enter device activity data indicative of a past activity of the mobile device to unlock the mobile device, and software executing on the processor for unlocking the mobile device in response to a correct entry of the device activity data. In some embodiments, the device activity data includes a location of the mobile device at a previous time.

In some embodiments, the software for prompting the user to enter the device activity data prompts the user in response to a security trigger, such as an irregular or uncharacteristic interaction with a user interface of the mobile device. In some embodiments, the irregular interaction is a haptic interaction or activity such as a rate or pressure of the interaction with the user interface that is uncharacteristic with prior interactions with the user interface. The system may further include software executing on the processor for receiving a passcode, wherein the security trigger is a receipt of an incorrect passcode.

Other objects of the present invention are achieved by provision of a mobile device including a user interface, a plurality of software modules receiving a plurality of device activity data concerning one or more activities of the mobile device, software executing on the mobile device for presenting, via the user interface, a prompt for first device activity data indicative of a past activity of the mobile device, software executing on the mobile device for receiving a response to the prompt via the user interface, and software executing on the mobile device for verifying the accuracy of the response and unlocking the mobile device if the response corresponds to the first device activity data.

In some embodiments, the user interface includes a touch screen and a keyboard. In some embodiments, the past activity is one of an email, a text, and a phone call.

Further provided is a method for securing and unlocking a mobile device, including the steps of storing a plurality of data associated with one or more activity performed via a mobile device, prompting a user, via a user interface of the mobile device, for information concerning a past activity performed via the mobile device, receiving a response to the prompt for information concerning the past activity, and unlocking the mobile device if a correct response is received. In some embodiments, the step of prompting the user includes presenting at least two response options to the user via a user interface and receives a selection of one of the at least two response options via the user interface.

In some embodiments, the user is prompted for information concerning the past activity in response to detection of a security trigger, such as an irregular or uncharacteristic interaction with a user interface of the mobile device.

Other objects of the invention and its particular features and advantages will become more apparent from consideration of the following drawings and accompanying detailed description.

### BRIEF DESCRIPTION OF THE DRAWINGS

FIG. 1A illustrates a system and mobile device according to exemplary embodiments of the present invention.

FIG. 1B illustrates a system and mobile device according to exemplary embodiments of the present invention.

FIGS. 2A to 2D illustrate mobile devices and displays according to exemplary embodiments of the present invention.

FIG. 3 illustrates a method of securing and unlocking a mobile device according to an exemplary embodiment of the present invention.

FIG. 4 illustrates a method of securing and unlocking a mobile device according to an exemplary embodiment of the present invention.

### DETAILED DESCRIPTION OF THE INVENTION

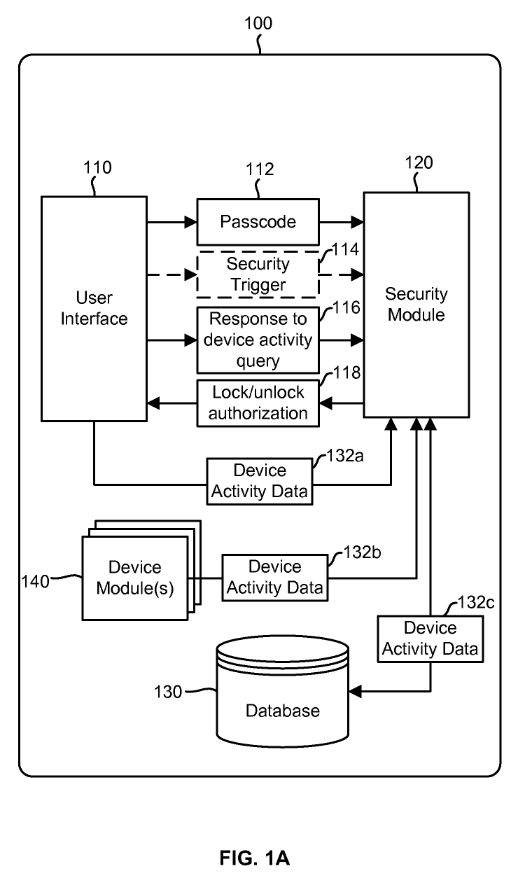

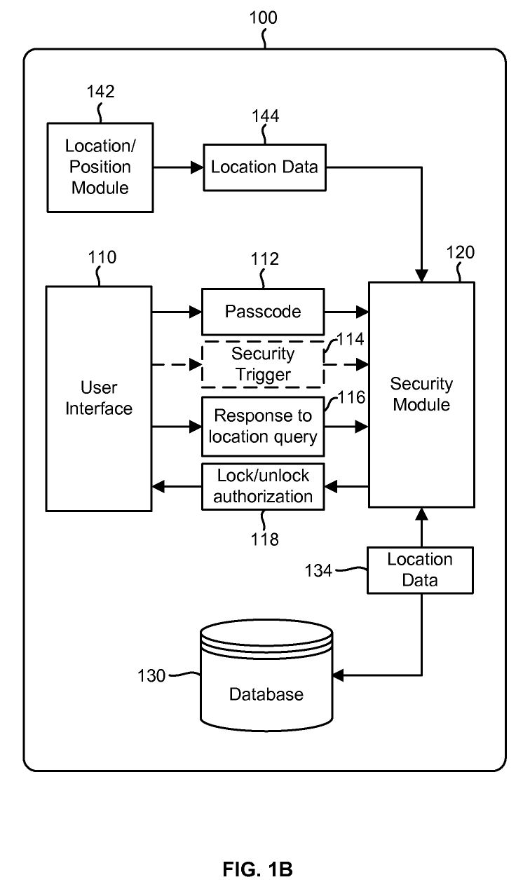

FIG. 1A shows a system and mobile device according to exemplary embodiments of the present invention. A mobile device (e.g., a smartphone) 100 is shown including a user interface 110. The user interface may be touch screen or other means to receive user input and/or display information. In some embodiments, the user interface includes a keyboard embodied in the touch screen or a separate fixed keyboard with physical keys.

The mobile device 100 includes a plurality of software modules executing on the mobile device 100, or a processor comprised in the mobile device 100. In particular, the mobile device 100 includes a security module 120 and one or more device modules 140. The device modules 140 may include any software modules and/or applications (e.g., apps) executing on the mobile device 100 to carry out its various functions, including but not limited to modules for email, instant messaging, texting, phone calls, calendars, contacts, maps, or directions. The device modules 140 may also include hardware components, including but not limited to cellular and non-cellular (e.g., Bluetooth, Wi-Fi, etc.) communication components.

Information entered or received via the user interface 110 is transmitted to one or more the software modules and/or the processor. In particular, the security module 120 may receive a passcode 112 entered via the user interface 110. The security modules 120 further receives user responses to queries 116, and provides lock and/or unlock authorizations or commands 118.

In some embodiments, the security module 114 further receives or detects a security trigger 116 via the user interface 110. The security trigger 116 may be unusual or irregular activity or interaction with the device 100, such as an interaction that is uncharacteristic of the user based on a comparison of the current activity to past stored interactions. For example, the mobile device 100 may detect and store haptic or tactile interactions with the device 100, such as the pressure or motions imposed on the user interface 110 by the user when entering the passcode or other information and detect uncharacteristic pressures or motions. In some embodiments, the mobile device 100 may further detect and store different finger prints or print sizes/shapes interacting with the device 100 or the hand (e.g., left or right) used to enter information. The mobile device 100 may also detect and store the placement of fingers on particular keys (e.g., the user always pushes the Return key on the top left) and determine whether the placement is uncharacteristic (e.g., the current user pushes the Return key on the bottom right). Further, the mobile device 100 may detect and store the time taken by the user between key strokes, e.g., an uncharacteristically slow entry of the passcode may be a security trigger.

The security trigger 116 may also be a position, orientation, or location of the device 100. For example, one of the device modules 140 may be an accelerometer or a gyro, and the device 100 may detect and storage the orientation in which the device 100 is typically in when the user enters the passcode (e.g., level, titled upward, titled left, etc.). The device 100 may also detect the location of the device 100 when the passcode is entered (e.g., a city, state, or country in which the user has never been). The security trigger 116 may also be a preset trigger such as the entry of an incorrect passcode a predetermined number of times. In some embodiments, the security module 114 also detects and stores security triggers via other parts of the mobile device 100, such as the device modules 140.

The mobile device 100 shown in FIG. 1A further includes at least one database 130 embodied in a storage or memory of the mobile device 100. For example, the database 130 may be embodied in a hard drive, flash memory, or random-access memory. Device activity data 132 may be stored in or retrieved from the database 130. Device activity data 132 may also be received from the user interface 110 and/or the device modules 140. As one of skill in the art would understand, the mobile device 100 may further include additional components including but not limited to a battery, speaker, microphone, and camera.

FIG. 1B shows a system and mobile device according to exemplary embodiments of the present invention. The system includes a location and/or positioning module 142. The module 142 may be embodied in software and/or hardware. For example, the module 142 may include software executing on the mobile device 100, or a processor thereof, for receiving and storing location data 144. The module 142 may further include a location antenna and/or receiver, such as a global positioning system (“GPS”) receiver. The system shown in FIG. 1B further includes at least one database 130. Location data 144 may be stored in or retrieved from the database 130.

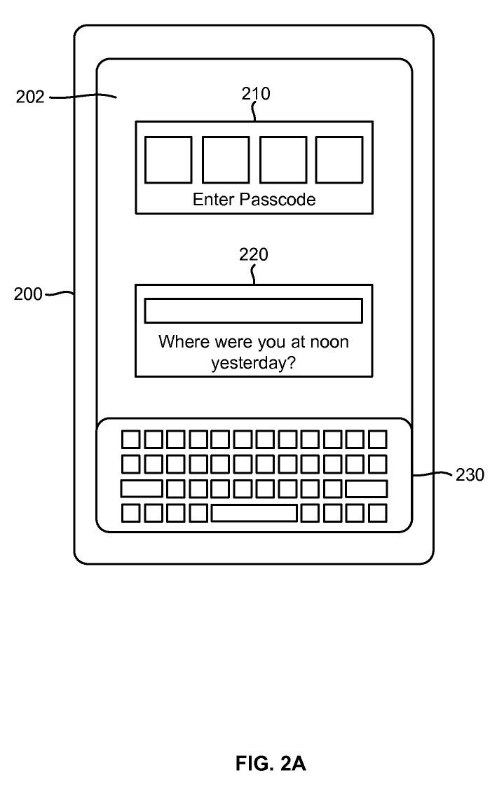

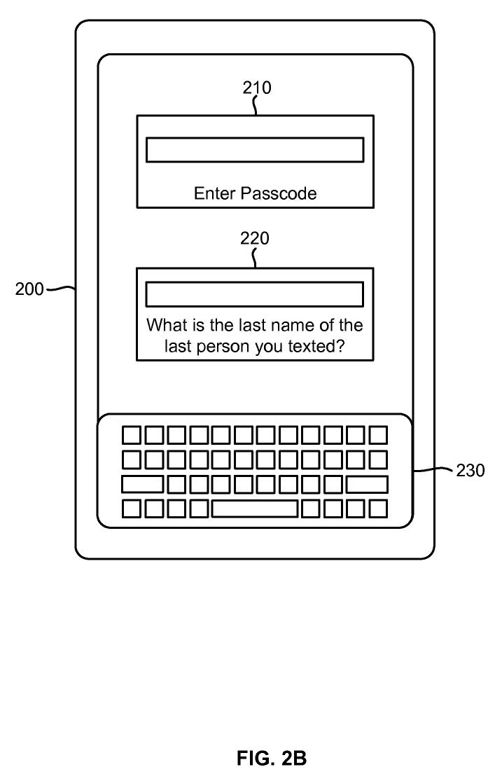

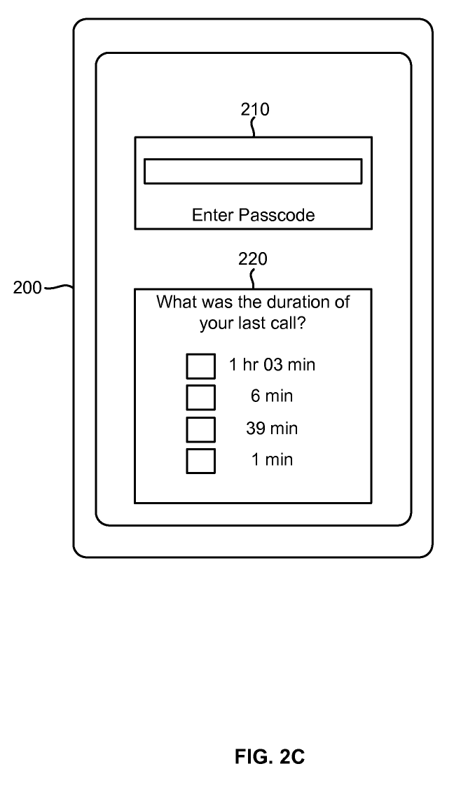

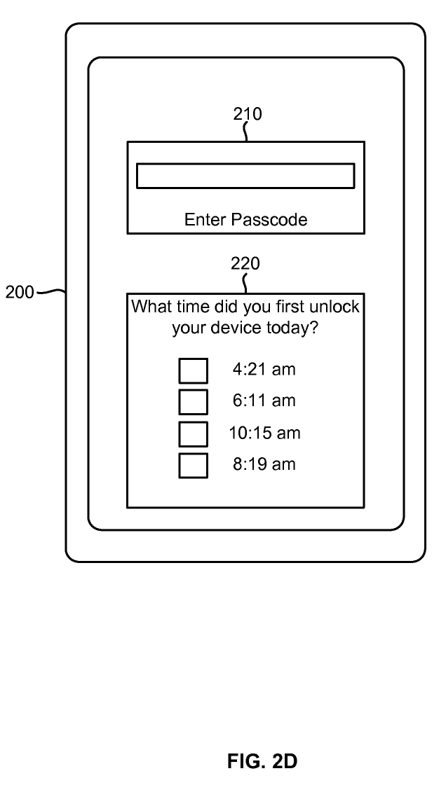

FIGS. 2A to 2D illustrate mobile devices and displays according to exemplary embodiments of the present invention. A mobile device 200 includes a user interface 202. The mobile device 200 may also include a keyboard 230. The keyboard 230 may be a touch screen keyboard in the user interface 202, a physical keyboard on the mobile device 200, or a separate auxiliary a keyboard. In some embodiments, the location of the keyboard 230, and/or the entry locations for the passcode 210 the device activity data 220, changes periodically (e.g., each time a user accesses the device) and appears in different areas of the user interface 202. This prevents smudges or marks, indicative of responses entered by the user, from being visible on the touch screen.

The mobile device 200 (e.g., via security software executing thereon) prompts the user for information to unlock and/or access the mobile device 200. For example, the mobile device 200 may prompt the user for a passcode or device activity data, or both. While visual prompts are illustrated in the FIGS. 2A-2D, the prompt may also be a voice prompt from the device 200 whereby the user is verbally asked from information. In some embodiments, verbal responses may be provided to the device 200 by the user, instead of or in addition to text responses via the user interface 202.

The passcode 210 may be any type of passcode such as a numeric or alpha-numeric passcode. In one embodiment, the passcode is at least five characters for increased security. The prompt 220 for device activity data may require the user to enter or speak information known to, or stored in, the device 200 relating to past activity on or by the device 200. In some embodiments, a user is required to enter or speak such activity data in addition to the passcode 210, while in other embodiments the device activity information may be a substitute for the passcode 210.

In one embodiment, the device activity data may be location-based. For example, as shown in FIG. 2A, the mobile device 200 may prompt the user to enter, speak or select a location at which the device 200 was at previous date/time. The mobile device 200 accesses past locations of the device 200 stored by the positioning module 140. The mobile device 200 may then present a blank entry field for the user or a list of response options (e.g., 2, 3, or 4 options) as shown in FIGS. 2C-2D. For example, the device 200 may prompt the user to enter or select a location (e.g., by address, town, state) that the user was previously at a particular time or during a time period (e.g., a one or two hour period during a given day). Software executing on the mobile device 200 receives a response to the query from the user. The device 200 may further prompt the user to identify one or more persons who they were with at the given location. The device 200 may determine and store persons who the user was with based on check-ins on social media applications and/or location tracking applications of users within the same company or organization.

In one embodiment, the device activity may be based on previous activities initiated or performed by the user via the mobile device 200. As shown in FIG. 2B, the mobile device 200 may prompt the user to enter or select the identity of the last person(s) with whom the user communicated (e.g., by email, text, phone) using the mobile device 200. The mobile device 200 may also prompt the user to identify the last application user on the mobile device 200, the application being used at a particular time in the past, or information entered or received via an application (e.g., creation of a calendar appointment or task, travel reservation booked or searched, a high score achieved in a game, etc.). Software executing on the mobile device 200 receives a response to the query from the user.

In some embodiments, the user may also be prompted to enter, speak or select a time or duration of a past activity. Software executing on the mobile device 200 then receives a response to the query from the user. As shown in FIG. 2C, the user may be prompted to enter, or select from a list of options, the duration of a phone call. As shown in FIG. 2D, the user may be prompted to enter a time at which the device was unlocked. Other examples include, but are not limited to, requiring the user to enter a time in which an alarm was set (in the past or future) or went off, the amount of times an alarm was snoozed in the past, information about upcoming appointments (e.g., time, location, duration) in a calendar application in the device 200, etc. This list is not intended to be exhaustive and the device activity data which the user is required to enter may include any information stored in the device 200 or otherwise likely to be known to the user by their interaction with and use of the device 200.

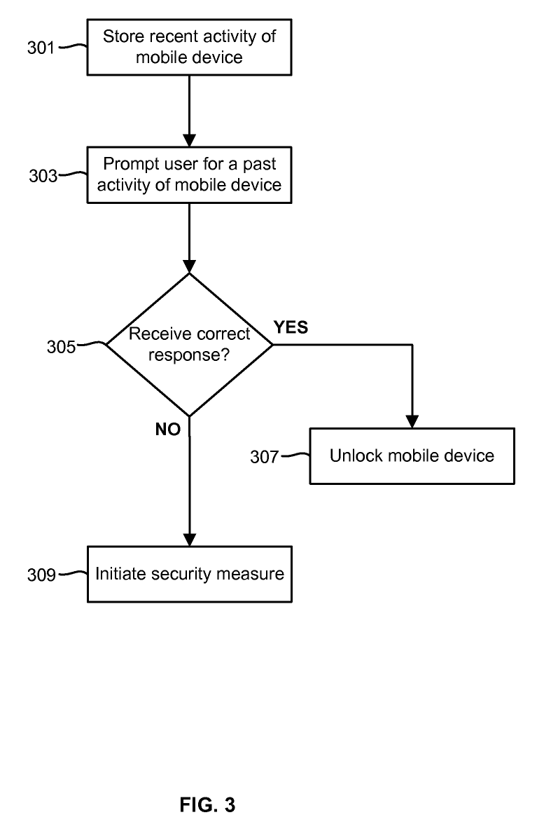

FIG. 3 illustrates a method of securing and unlocking a mobile device according to an exemplary embodiment of the present invention. The method includes a step of storing recent activity of the mobile device (step 301). This may include, e.g., information about the user's interaction with the device as discussed above. The activity may also include locations at which the device was at various times in the past. The method further includes a step 303 of prompting the user (e.g., visually or audibly) to enter or speak information about a past activity. A response is then received from the user. If the response received from the user is correct, the mobile device is unlocked (step 305-307). If the response is incorrect, security measures are initiated (step 309). The security measures may include, e.g., restricting the number of additional attempts to unlock, permanently locking the device, wiping the device, and/or contacting the owner (e.g., via email). In some embodiments, the security measures include photographing the current user (via a camera in the mobile device) and sending the photographs to the device owner and/or authorities.

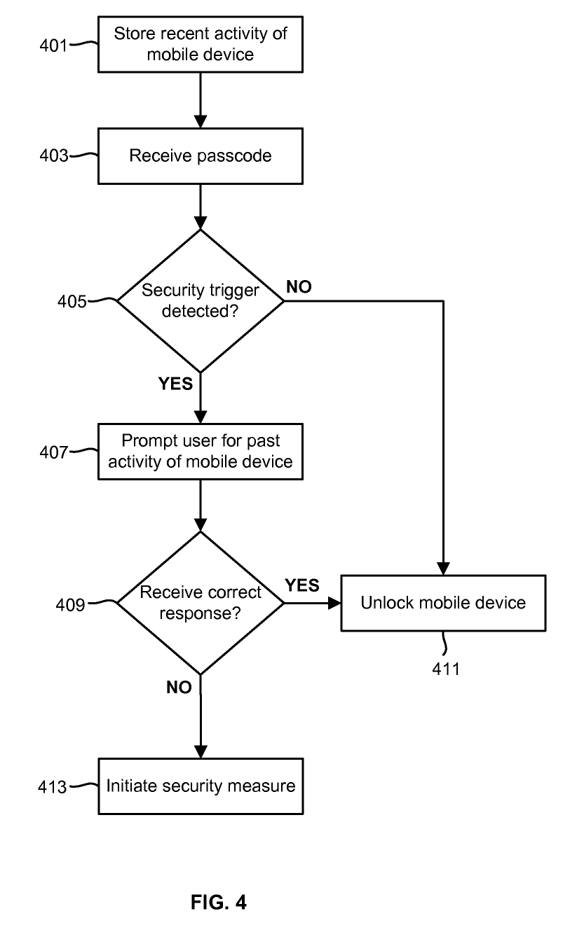

FIG. 4 illustrates a method of securing and unlocking a mobile device according to an exemplary embodiment of the present invention. The method includes the steps of storing recent activity of the mobile device (step 401) and receiving a passcode (step 403). If a security trigger is detected, the current user is prompted for information about a past activity of the mobile device (steps 405-407). A response is then received from the user. If the response is correct, the mobile device is unlocked (step 409-411). If the response is incorrect, security measures are initiated (step 413).

Although the invention has been described with reference to a particular arrangement of parts, features and the like, these are not intended to exhaust all possible arrangements or features, and indeed many modifications and variations will be ascertainable to those of skill in the art.

What is claimed is:

1. A system for securing and unlocking a mobile device, comprising:
a mobile processor;
software executing on the processor for storing a plurality of device activity data;
software executing on the processor for prompting a user to enter device activity data indicative of a past activity of the mobile device to unlock the mobile device; and
software executing on the processor for unlocking the mobile device in response to a correct entry of the device activity data.

2. The system according to claim 1, wherein the plurality of device activity data includes locations of the mobile device at previous times.

3. The system according to claim 2, further comprising:
a positioning module, wherein the location is received from said positioning module.

4. The system according to claim 1, wherein said software for prompting the user presents at least two response options to the user via a user interface and receives a selection of one of the at least two response options via the user interface.

5. The system according to claim 1, wherein said software for prompting the user to enter the device data prompts the user in response to a security trigger.

6. The system according to claim 5, wherein the security trigger is an irregular interaction with a user interface of the mobile device.

7. The system according to claim 6, wherein the irregular interaction includes at least one of a rate and pressure of the interaction with the user interface that is uncharacteristic with prior interactions with the user interface.

8. The system according to claim 5, further comprising software executing on the processor for receiving a passcode, wherein the security trigger is a receipt of an incorrect passcode.

9. The system according to claim 1, further comprising software executing on the processor for receiving a passcode, wherein said software for unlocking the mobile device in response to a correct entry of the device activity data further requires correct entry of the passcode.

10. A mobile device, comprising:
a user interface;
a plurality of software modules receiving a plurality of device activity data concerning one or more activities of the mobile device;
software executing on the mobile device for presenting, via said user interface, a prompt for first device activity data indicative of a past activity of the mobile device;
software executing on the mobile device for receiving a response to the prompt via the user interface; and
software executing on the mobile device for verifying the accuracy of the response and unlocking the mobile device if the response corresponds to the first device activity data.

11. The mobile device according to claim 10, wherein the past activity is one of an email, a text, and a phone call.

12. The mobile device according to claim 10, wherein said user interface comprises a touch screen.

13. The mobile device according to claim 10, wherein the first device activity data includes a location of the mobile device at a previous time.

14. The mobile device according to claim 13, further comprising:
a global positioning system receiver, wherein the location is provided by said global positioning system receiver.

15. A method for securing and unlocking a mobile device, comprising the steps of:
storing a plurality of data associated with one or more activity performed via a mobile device;
prompting a user, via a user interface of the mobile device, for information concerning a past activity performed via the mobile device;
receiving a response to the prompt for information concerning the past activity; and
unlocking the mobile device if a correct response is received.

16. The method according to claim 15, wherein the step of prompting the user includes presenting at least two response options to the user via a user interface and receives a selection of one of the at least two response options via the user interface.

17. The method according to claim 15, further comprising the step of:
receiving a passcode, wherein the step of unlocking the mobile device further requires correct entry of the passcode to unlock the mobile device.

18. The method according to claim 15, wherein the user is prompted for information concerning the past activity in response to detection of a security trigger.

19. The method according to claim 18, wherein the security trigger is an irregular interaction with a user interface of the mobile device.

20. The method according to claim 15, wherein the step of storing data associated with one or more activity performed via a mobile device includes storing locations of the device at particular times, wherein the information concerning the past activity includes one of the location of the device at a particular time.
